(19) United States
(12) Patent Application Publication
(10) Pub. No.: US 2009/0201775 A1
(43) Pub. Date: Aug. 13, 2009

(54) Optical Disc Apparatus and Method for Discriminating Optical Disc

(75) Inventors: Hideaki TANAKA, Yokohama (JP); Seiji INABA, Yokohama (JP); Hiroharu SAKAI, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-LG Data Storage, Inc.

(21) Appl. No.: 12/327,839

(22) Filed: Dec. 4, 2008

(30) Foreign Application Priority Data
Feb. 13, 2008 (JP) 2008-031698

(51) Int. Cl. G11B 7/00

(52) U.S. Cl. 369/44.13; 369/53.22; G9B/7

(57) ABSTRACT

This invention improves the accuracy of wobble signal detection for disc discrimination and reduces discrimination errors due to noise. In an optical disc apparatus, a wobble signal generator creates a wobble signal from an electrical signal which has been obtained from conversion by a pickup. A bandpass filter (BPF) is set to change its central frequency to a wobble frequency f0 and to fn different from the wobble frequency, and the filter extracts the respective frequency components from the wobble signal. An amplitude-measuring section measures amplitude levels A0 and An of the extracted multiple signals. A disc discriminator compares the multiple amplitude levels and if the amplitude A0 is greater than the amplitude An by at least a threshold level Ath, judges that a wobble is present.

### CLAIM OF PRIORITY

The present application claims priority from Japanese patent application JP 2008-031698 filed on Feb. 13, 2008, the content of which is hereby incorporated by reference into this application.

### BACKGROUND OF THE INVENTION

(1) Field of the Invention

The present invention relates to an optical disc apparatus capable of discriminating the kind of optical disc by detecting a wobble signal and a method for discriminating an optical disc.

(2) Description of the Related Art

Optical disc apparatuses discriminate the kind of mounted optical disc by a combination of factors such as the depth of the recording layer, the reflectance of the disc, the presence/absence of a wobble signal, and the settings of control data. Whether the disc is intended for recording or for reproduction only, however, can be discriminated from the presence/absence of a wobble signal, not from the above combination. That is to say, whereas DVD-R/RW and DVD+R/RW discs, both for recording, have a land and grooves formed on the surface and these grooves are of a wobble shape with each groove winding its way along the surface at required intervals, the grooves on DVD-ROM discs, which are dedicated media for reproduction, are constructed only of pits and do not have the wobble shape.

Techniques for discriminating a disc using a wobble signal have been proposed as follows. JP-A-4-123320 describes discriminating a recordable optical disc by extracting the wobble frequency components contained in a tracking error signal of the tracks winding their way along the surface with a required wobble period. JP-A-2006-179138 describes discriminating the kind of optical disc by measuring the period of a wobble signal a plurality of times from the optical disc, then creating a histogram that is formed up of the measured period and the frequency of occurrence of the signal, and analyzing its frequency distribution status.

### SUMMARY OF THE INVENTION

During the discrimination of the kind of optical disc, the wobble signal is detected by irradiating the rotating disc with a beam of light and then processing the resulting return light with a signal-processing section. At that time, the wobble signal can be efficiently extracted by using a band-pass filter that lets only specific frequency components associated with the wobble period pass through.

Simplifying the signal-processing circuit in an attempt to reduce apparatus costs, however, increases the internal noise of the circuit, thus deteriorating the S/N ratio of the wobble signal to be detected. If the above filter is used in such a case, the same frequency components as those of the wobble signal, that is, pseudo wobble signals will be extracted from the noise signal. As a result, a disc not having the wobble (e.g., a DVD-ROM disc) will be erroneously discriminated as a disc having the wobble (e.g., a DVD-RW disc). The occurrence of this discrimination error will make it absolutely necessary to restart the discrimination itself by use of a different technique, resulting in a delay in setup process.

The foregoing Publications give no consideration to a discrimination error due to the occurrence of noise in the wobble signal detection circuit. The technique described in JP-A-2006-179138 is intended to discriminate the kind of disc from the frequency distribution of the wobble signal, but does not avoid the above influence of the noise.

An object of the present invention is to improve wobble signal detection accuracy and reduce discrimination errors due to noise.

The present invention provides, as an aspect thereof, an optical disc apparatus capable of discriminating the kind of optical disc by detecting a wobble formed on the optical disc. The optical disc apparatus comprises: a pickup which irradiates an optical disc with laser light and then converts into an electrical signal the light reflected from the optical disc; a wobble signal generator which creates a wobble signal from the electrical signal which has been obtained by the conversion; a bandpass filter which extracts signal components of a desired band from the wobble signal by changing a central frequency of the filter into a plurality of frequencies; an amplitude-measuring section which measures amplitude levels of each of the plural signals which the bandpass filter has extracted; and a disc discriminator which compares the amplitude levels that the amplitude-measuring section has measured, and judges whether or not the wobble is actually present based on comparison results.

In this example, when the wobble formed on the optical disc has a frequency f0, the bandpass filter is set to change its central frequency to f0 and to fn different therefrom, and the disc discriminator compares amplitude A0 of a wobble signal extracted when the central frequency of the bandpass filter is equal to f0, and amplitude An of another wobble signal extracted when the central frequency is equal to fn, and judges the presence of the wobble if the amplitude A0 is greater than the amplitude An. At this time, the presence of the wobble is preferably discriminated if the amplitude A0 is greater than the amplitude An by at least a threshold level Ath.

The present invention provides, as another aspect thereof, a method for discriminating the kind of optical disc by detecting a wobble formed on the optical disc. This discrimination method comprises: irradiating an optical disc with laser light and then converting into an electrical signal the light reflected from the optical disc; creating a wobble signal from the electrical signal which has been obtained from the conversion; extracting signal components of a desired band from the wobble signal by using a bandpass filter whose central frequency has been changed into a plurality of frequencies; measuring amplitude levels of each of the plural signals which have been extracted; and judging whether the wobble is actually present, by comparing the measured amplitude levels.

According to the present invention, wobble signal detection accuracy can be improved and disc discrimination errors reduced. This minimizes a delay in setup process.

### BRIEF DESCRIPTION OF THE DRAWINGS

These and other features, objects and advantages of the present invention will become more apparent from the following description when taken in conjunction with the accompanying drawings, wherein:

FIG. 1 is a block diagram showing a first embodiment of an optical disc apparatus of the present invention;

FIGS. 2A and 2B are block diagrams associated with disc discrimination in FIG. 1;

FIG. 3 is a diagram that describes principles of disc discrimination in the first embodiment;

FIG. 4 is a flowchart showing a second embodiment that is an example of a disc discrimination method;

FIG. 5 is a flowchart showing a third embodiment that is another example of a disc discrimination method; and

FIG. 6 is a diagram showing an example of wobble signal amplitude measurement results obtained using different bandpass filter (BPF) parameters.

### DETAILED DESCRIPTION OF THE EMBODIMENTS

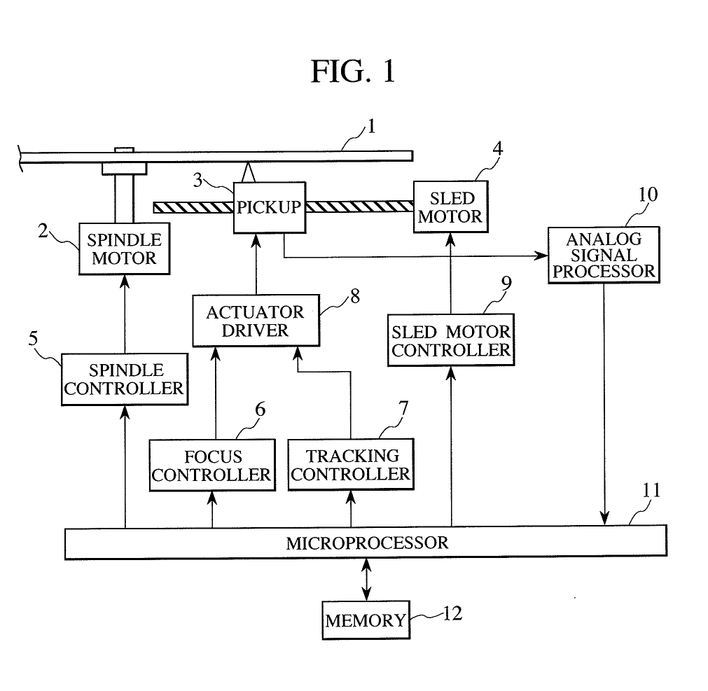

FIG. 1 is a block diagram showing a first embodiment of an optical disc apparatus of the present invention.

The optical disc apparatus rotates an optical disc 1 using a spindle motor 2, then irradiates the optical disc 1 with laser light from a pickup 3, and reads out data using the resulting return light. Also, moving the pickup 3 in a radial direction by means of a sled motor changes a location of the data to be read out. The return light that has been input to the pickup 3 is converted into electrical signals, which are then sent to an analog signal processor 10 to reproduce the data (information) and to generate a tracking error (TE) signal, a focus error (FE) signal, and more. A microprocessor 11 calculates control quantities for the spindle motor 2, the pickup 2, and the sled motor 4, from these signals and sends control signals to a spindle controller 5, a focus controller 6, a tracking controller 7, and a sled motor controller 9. After receiving the associated control signal, each of the controllers drives the intended constituent element of the apparatus in accordance with the control signal. The pickup 3 is driven via an actuator driver 8.

In addition, in the present embodiment, the analog signal processor 10 detects a wobble signal from the light that has been returned from the pickup 3, and the microprocessor 11 discriminates the kind of mounted optical disc from amplitude of the detected wobble signal. Data to be used for disc discrimination is stored in a memory 12. Upon completion of disc discrimination, the microprocessor 11 sets up operating parameters for each section according to the discriminated kind of disc.

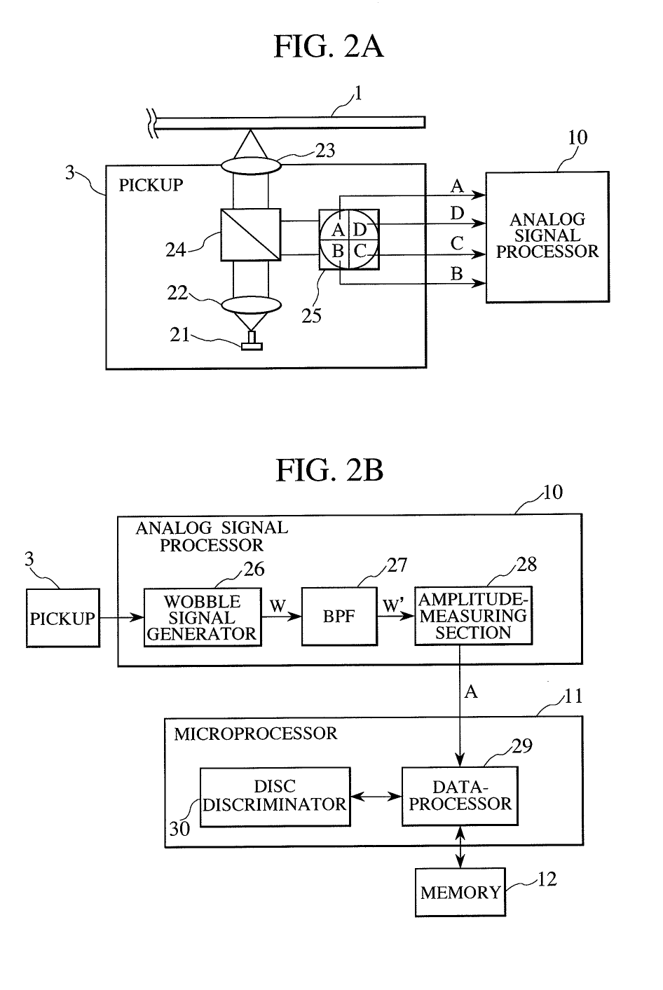

FIGS. 2A and 2B are block diagrams associated with disc discrimination in FIG. 1; FIG. 2A shows an internal configuration of the pickup, and FIG. 2B shows internal configurations of the analog signal processor and the microprocessor.

The pickup 3 in of FIG. 2A uses a collimator lens 22 to convert the light emitted from a laser diode (LD) 21, into parallel light and then uses an objective lens 23 to form a beam spot on the optical disc 1. The light that has been reflected therefrom is further reflected in a direction of a photoreceptor 25 by a polarizing beam splitter (PBS) 24. The photoreceptor 25 splits the reflected light into four beams and converts the beams into electrical signals A, B, C, and D, which are then sent to the analog signal processor 10.

The analog signal processor 10 in FIG. 2B detects the wobble signal W from the electrical signals that have been received from the pickup 3. First, a wobble signal generator 26 converts the electrical signals A, B, C, D into the wobble signal W. At this time, the wobble signal W can be generated from a calculation result of W=(A+D)−(B+C). A bandpass filter (BPF) 27 extracts required band components as a signal W′ from the wobble signal W. An amplitude-measuring section 28 measures amplitude A of the extracted wobble signal W′. More specifically, the amplitude A is calculated from a top envelope and bottom envelope of the wobble signal W′. At this time, a central frequency “f” of the BPF 27 is varied and the amplitude A of the wobble signal is measured for each central frequency.

Next, the microprocessor 11 discriminates the kind of disc from the amplitude A of the wobble signal. A data-processor 29 receives amplitude data of the wobble signal and stores the data into the memory 12. A plurality of sets of amplitude data A are stored into the memory 12 by varying the central frequency “f” of the BPF 27. After a required number of sets of amplitude data have been stored into the memory 12, the data is transmitted to a disc discriminator 30. The disc discriminator 30 compares each set of amplitude data A and discriminates the disc. Discrimination results are stored into the memory 12 through the data-processor 29 and used to control various internal components of the apparatus.

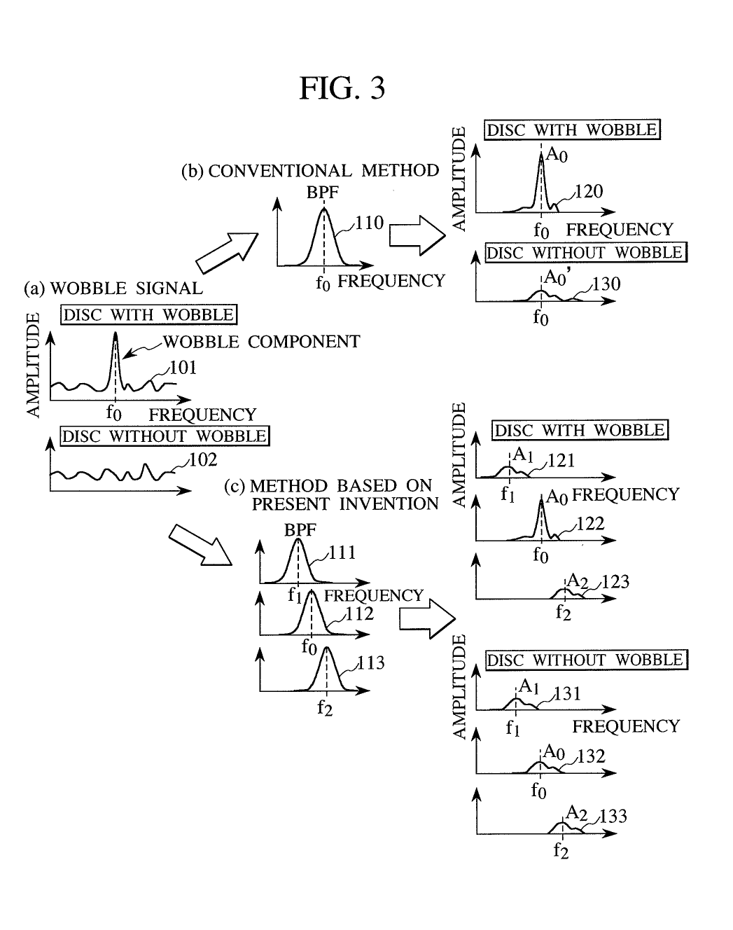

FIG. 3 is a diagram that describes principles of disc discrimination in the present embodiment.

Section (a) of FIG. 3 shows frequency characteristics of the wobble signal obtained from the optical disc. While a disc 101 having wobbles, such as a DVD-RW disc, has an amplitude peak at a wobble frequency f0, a disc 102 having no wobble, such as a DVD-ROM disc, exhibits no significant amplitude rises at any specific frequencies and is essentially flat in amplitude. The wobble frequency f0 is about 140 kHz for a standard-speed DVD-RW disc, and about 280 kHz for a double-speed DVD-RW disc.

Section (b) of FIG. 3 shows a conventional discrimination method for comparison purposes. A bandpass filter (BPF) 110 is used to extract a component of the wobble frequency f0. This filter 110 has a bandwidth of 100 kHz, for example. The signal W′ that has passed through the filter in the disc 101 having wobbles has a steep amplitude peak at the wobble frequency f0, as denoted by reference number 120, and the peak amplitude is defined as A0, for example. In the wobble-less disc 102, the signal W′ has a gentle amplitude peak at f0, as denoted by reference number 130, and the peak amplitude is defined as A0′, for example. This is because the passage through the BPF 110 leaves a noise component of the same frequency f0 as the wobble frequency. The amplitude A0′ takes a value smaller than that of the amplitude A0 of the signal 120, but whether a wobble is present or not is difficult to judge with the amplitude A0′ only. For this reason, the wobble-less disc 102 is liable to be erroneously discriminated as a disc having wobbles.

Section (c) of FIG. 3 shows a discrimination method based on the present embodiment. The present embodiment uses plural kinds of bandpass filters (in the present example, three kinds, BPF 111, 112, and 113) as BPFs 27. The BPF 112 is set to operate with standard data including the same central frequency as the wobble frequency f0, whereas central frequencies of the BPFs 111 and 113 are changed to f1 and f2, respectively. For example, f1=0.5×f0, and f2=2.0×f0. Amplitude levels of the signals which have been passed through these BPFs are compared. The signals W′, after being passed through the BPFs 111, 112, and 113 in the disc 101 having wobbles are denoted by reference numbers 121, 122, and 123, respectively. The amplitude-measuring section 28 measures the amplitude levels A1, A0, and A2 of the signals W′. When these amplitude levels are compared in the disc discriminator 30, the amplitude level A0 of the signal W′ passed through the BPF 112 is always larger than the amplitude levels A1 and A2 of the other signals W′, and the differences exceed a required value (A0>>A1, A2). Signals that have been passed through the BPFs 111, 112, and 113 in the wobble-less disc 102 are denoted by reference numbers 131, 132, and 133, respectively. Almost no differences exist between the respective amplitude levels A1, A0, and A2 when they are compared with each other. For these reasons, when the amplitude level A0 of the signal passed through the BPF 112 whose central frequency is equal to the wobble frequency f0 is larger than the amplitude levels A1 and A2 of the other signals, the disc in question is judged to have wobbles. Even for a disc without wobbles, the amplitude level A0 may be slightly larger than the other amplitude levels A1, A2, so in order to exclude this case, if the differences are equal to or greater than the threshold level Ath, the disc is judged to have wobbles.

Although the above example has assumed using three kinds of BPFs, this number can be properly changed to suit the particular frequency characteristics of the wobble signal obtained from the disc. The central frequencies of each BPF can also be changed as appropriate.

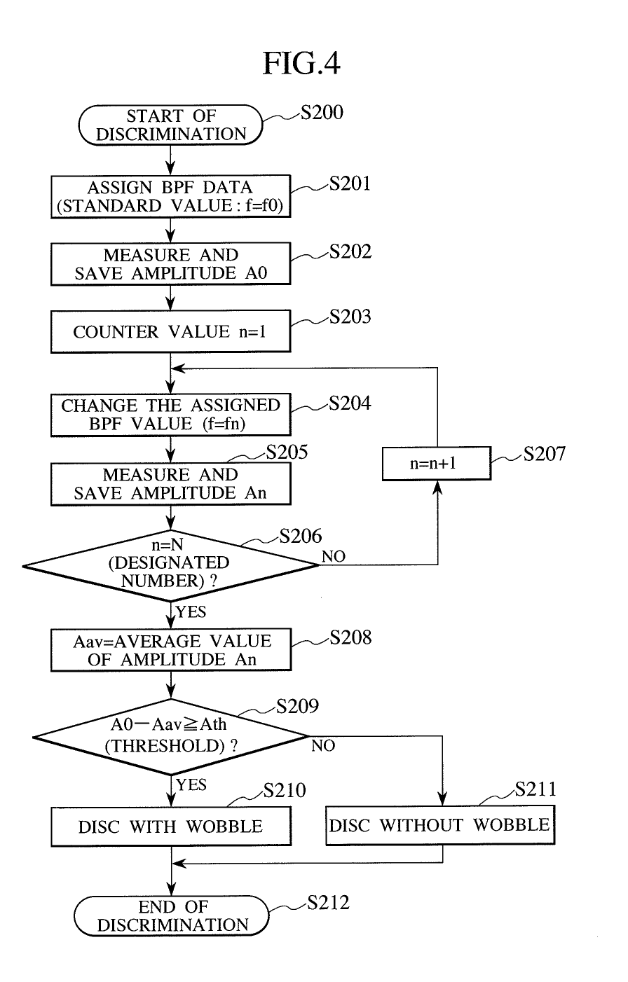

FIG. 4 is a flowchart showing a second embodiment that is an example of a disc discrimination method based on the present invention. This example uses an N number of BPFs in addition to standard BPF data setting.

In step S200, a mounted disc is rotated and after optical beam irradiation, the resulting return light signals are input to start disc discrimination.

In step S201, the central frequency “f” of the BPF 27 is set to equal the wobble frequency f0 (standard setting).

In step S202, amplitude A0 of a filtered signal is measured by the amplitude-measuring section 28 and the measured value is saved in the memory 12.

In step S203, n=1 is assigned as a counter value.

In step S204, the central frequency “f” of the BPF 27 is changed to fn (initially, n=1) that is different from the wobble frequency f0. For example, the central frequency is set at equal intervals in accordance with fn=(n+1)×f0. Needless to say, the central frequency may be set at unequal intervals.

In step S205, amplitude An of another filtered signal is measured by the amplitude-measuring section 28 and the measured value is saved in the memory 12.

In step S206, it is judged whether the counter value “n” has reached a designated number of setting operations, N. If the designated number of setting operations have not been completed, 1 is added to the counter value “n” in step S207 and then after control has been returned to step S204, the central frequency “f” of the BPF 27 is changed to next value. After this, the amplitude An is measured in step S205 and the measured value is saved in the memory 12. Subsequently, this sequence is repeated to change the operating data of the BPF 27 the N number of times and measure the amplitude An.

If the designated number of setting operations, N, is reached as the counter value “n” in step S206, control is transferred to step S208, in which step, values that the amplitude An takes when “n” is from 1 to N are then read out from the memory 12 and an average of these values is calculated as Aav.

In step S209, the amplitude A0 for the standard setting of the central frequency is compared with the average value Aav. If the two values differ by the threshold level Ath or more, processing advances to step S210, in which step, the signal A0 that was measured in step S202 is judged to be due to a wobble and thus the disc in question is discriminated as a disc having wobbles.

If the difference between A0 and Aav is smaller than Ath, however, processing advances to step S211 and the disc is discriminated as a disc not having a wobble.

Disc discrimination is terminated in step S212.

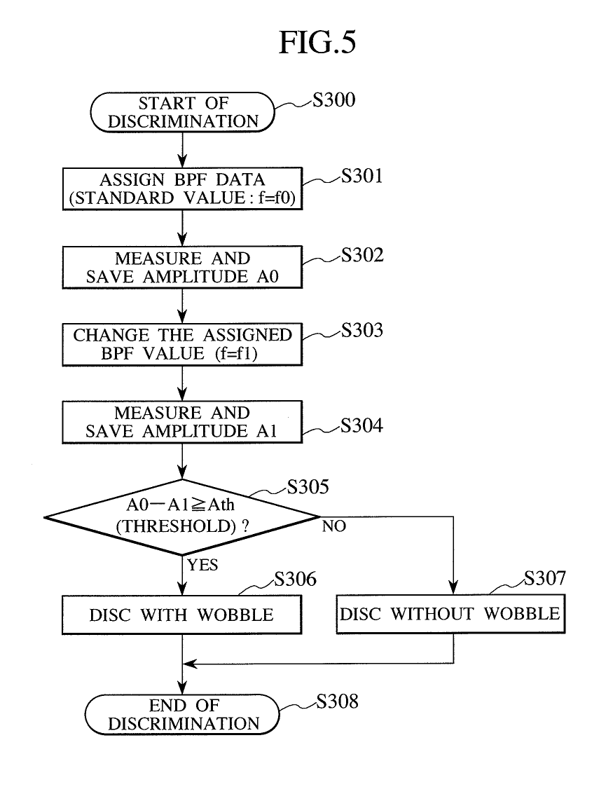

FIG. 5 is a flowchart showing a third embodiment that is yet another example of a disc discrimination method. This example uses the number of BPFs that is associated with N=1 in FIG. 4.

In step S300, a mounted disc is rotated and after optical beam irradiation, the resulting return light signals are input to start disc discrimination.

In step S301, the central frequency “f” of the BPFs is set to equal the wobble frequency f0 (standard setting).

In step S302, amplitude A0 of a filtered signal is measured and the measured value is saved in the memory.

In step S303, the central frequency “f” of the BPFs is changed to f1 different from the wobble frequency f0. For example, “f” is changed so that f1=2×f0.

In step S304, amplitude Al of another filtered signal is measured and the measured value is stored in the memory.

In step S305, the amplitude levels A0 and A1 are read out from the memory for comparison. If the two values differ by the threshold level Ath or more, processing advances to step S306, in which step, the signal A0 that was measured in step S302 is judged to be due to a wobble and thus the disc in question is discriminated as a disc having wobbles.

If the difference between A0 and A1 is smaller than Ath, however, processing advances to step S307 and the disc is discriminated as a disc not having a wobble.

Disc discrimination is terminated in step S308.

This discrimination method has an advantageous effect in that since two kinds of BPFs are only used, a measuring time it takes for discrimination can be reduced.

In FIGS. 4 and 5, comparative computing expressions for discrimination can be changed as appropriate. In step S208, while the average value Aav of the amplitude levels An (n=1 to N) was used, a maximum value Amax of these amplitude levels An (n=1 to N) may be calculated and compared with the amplitude A0. In addition, in steps S209 and S305, while the difference between A0 and Aav (A1) was compared with the threshold level Ath, a ratio between A0 and Aav (A1) may be compared with a threshold level Ath′.

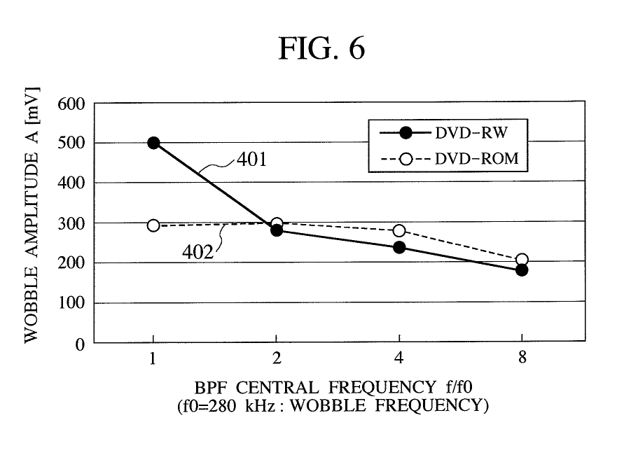

FIG. 6 is a diagram showing an example of wobble signal amplitude measurement results obtained using different BPF parameters. These measurement results relate to a DVD-RW disc with wobbles, and a DVD-ROM without wobbles. A horizontal axis denotes a setting of the central frequency “f” of BPFs, and as shown, the setting is changed at unequal intervals so that f/f0=1, 2, 4, 8, in which expression, f0 denotes a wobble frequency of about 280 kHz (for double-speed operation) of the DVD-RW disc. For this DVD-RW disc (denoted by reference number 401), its amplitude increases for the setting of f/f0=1 (standard setting), but decreases for other settings. In contrast to the DVD-RW disc, the DVD-ROM disc (denoted by reference number 402) exhibits no significant difference in amplitude. These measurements indicate that threshold levels suitable for disc discrimination are Ath=100 mV in terms of amplitude difference and Ath′=1.3 in terms of amplitude ratio.

As set forth above, according to the present embodiment, whether or not the optical disc has wobbles is judged by changing the central frequency of the BPFs which detect the wobble signal, and comparing the amplitude levels obtained. This judging method reduces discrimination errors due to noise. Although the discrimination between DVD-RW and DVD-ROM discs has been described by way of example in the present embodiment, the present invention can likewise be applied to discrimination between DVD-R, DVD+RW, and DVD+R discs, by assigning the appropriate central frequency of the BPFs according to wobble frequency.

While we have shown and described several embodiments in accordance with our invention, it should be understood that the disclosed embodiments susceptible of changes and modifications without departing from the scope of the invention. Therefore, we do not intend to be bound by the details shown and described herein, but intend to cover all such changes and modifications that fall within the ambit of the appended claims.

What is claimed is:

1. An optical disc apparatus adapted to discriminate the kind of optical disc by detecting a wobble formed on the optical disc, the apparatus comprising:
a pickup which irradiates an optical disc with laser light and then converts into an electrical signal the light reflected from the optical disc;
a wobble signal generator which creates a wobble signal from the electrical signal into which the reflected light has been converted by the pickup;
a bandpass filter which extracts signal components of a desired band from the wobble signal by changing a central frequency of the filter into a plurality of frequencies;
an amplitude-measuring section which measures amplitude levels of each of the plural signals which the bandpass filter has extracted; and
a disc discriminator which compares the amplitude levels that the amplitude-measuring section has measured, and then judges whether or not the wobble is actually present based on the comparison results.

2. The optical disc apparatus according to claim 1, wherein, when a frequency of the wobble formed on the optical disc is defined as f0:
the bandpass filter is set to change the central frequency thereof to f0 and to fn different therefrom; and
the disc discriminator compares amplitude A0 of a wobble signal extracted when the central frequency of the bandpass filter is equal to f0, and amplitude An of another wobble signal extracted when the central frequency of the bandpass filter is equal to fn, and then if the amplitude A0 is greater than the amplitude An, judges that the wobble is actually present.

3. The optical disc apparatus according to claim 2, wherein:
the disc discriminator compares the amplitude A0 and the amplitude An, and then if the amplitude A0 is greater than the amplitude An by at least a threshold level Ath, judges that the wobble is actually present.

4. The optical disc apparatus according to claim 1, discrimination is performed for DVD-RW, DVD-R, and DVD-ROM as an optical disc.

5. A disc discrimination method for discriminating the kind of optical disc by detecting a wobble formed on the optical disc, the apparatus comprising:
irradiating an optical disc with laser light and then converting into an electrical signal the light reflected from the optical disc;
creating a wobble signal from the electrical signal which has been obtained from the conversion;
extracting signal components of a desired band from the wobble signal by using a bandpass filter whose central frequency has been changed into a plurality of frequencies;
measuring amplitude levels of each of the plural signals which have been extracted; and
judging whether the wobble is actually present, by comparing the measured amplitude levels.
